(19) United States
(12) Patent Application Publication
(10) Pub. No.: US 2008/0218148 A1
(43) Pub. Date: Sep. 11, 2008

(54) Intelligent Power Control

(76) Inventors: Mark Laverne Robertson, Greensboro, NC (US); William W. Foard, Durham, NC (US)

Correspondence Address: Mark L. Robertson, 2122 New Garden Road, Greensboro, NC, 27410, US

(21) Appl. No.: 11/684,594

(22) Filed: Mar. 10, 2007

(51) Int. Cl. H02J 3/00

(52) U.S. Cl. 323/349; 323/318

(57) ABSTRACT

The Power Control Device can communicate with connected load or appliance for identification and control, and Intelligent Power Control. The Power Control combines Triac (or similar technology) function with Relay (or similar technology) function in a single intelligent current and temperature sensing multipurpose Dual Mode device. This combination of modes and the ability to automatically switch between them provides the capability to provide dimming to appropriate appliances as well as provide high power to devices not requiring dimming or variable power control. One embodiment is a universal power outlet which does not need to be dedicated to one function but can serve as a dimmer or as a full power relay switched circuit. The Power Control Device has sensing, reporting, control and interface capabilities necessary for a high function automation system. These include interface to command or controller systems, ability to sense states and function with partial or full autonomy.

### BACKGROUND OF THE INVENTION

While developing a home automation system and thinking of capabilities that needed to be included, we recognized that the available power control devices do not have the features and capabilities we thought necessary to implement our desired system functionality. We therefore took a fresh design approach including such features as dual mode operation, appliance identification and other features.

### BRIEF DESCRIPTION

An Intelligent Power Control System (IPCS), including cooperating System Controller, Power Control Device(s), and Load Device(s) and Appliance(s) are described, which provide enhanced power control capabilities. The IPCS System Controller and Power Control Device(s) have an ability to communicate with connected IPCS-enabled load devices and appliances for identification and control, and the IPCS System Controller and Power Control Device(s) use this and other features to provide new capabilities in power control, including plug-and-play style configuration and load-appropriate supply of power to attached loads and appliances. The IPCS Power Control Device combines Triac (or similar technology) function with Relay (or similar technology) function in a single intelligent current and temperature sensing multipurpose Dual Mode device. This combination of modes and the ability to automatically switch between them provides the capability to provide dimming to appropriate appliances such as incandescent lamps as well as provide high power to devices for which dimming or variable power control is not appropriate. One embodiment is a universal power outlet which does not need to be dedicated to one function but can serve as a dimmer or as a full power relay switched circuit depending on what appliance is plugged into it. The Power Control Device also has a large array of sensing, reporting, control and interface capabilities necessary for a high function automation system. These include interface to command or controller systems (optical, wire, or wireless), ability to sense states and function with partial or full autonomy (internal processor and memory).

### Circuit Operation Descriptions:

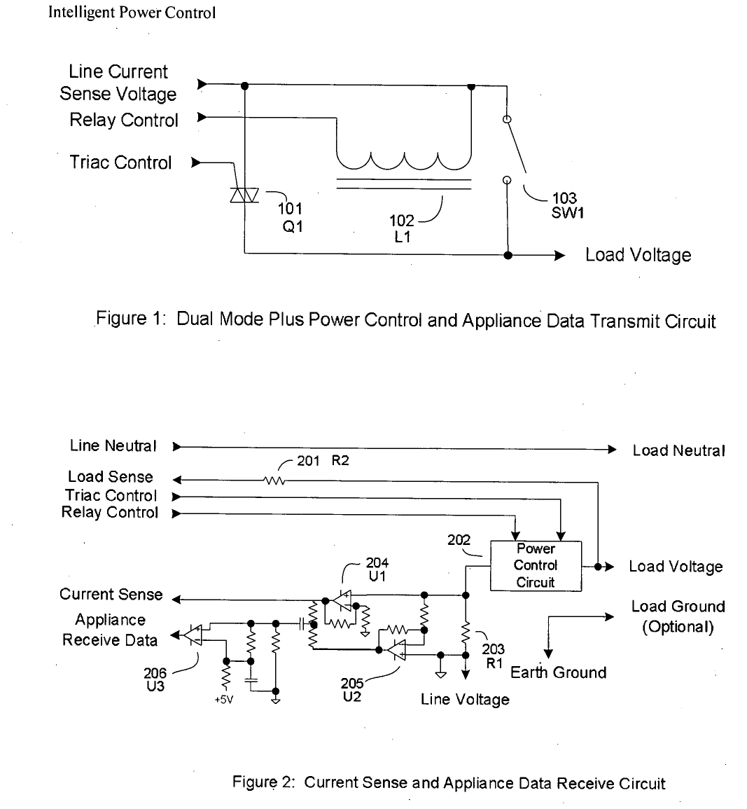

### FIG. 1: Dual Mode Plus Power Control and Appliance Data Transmit Circuit

FIG. 1 shows one practical implementation of the Dual Mode control feature. In this figure, the triac 101 (Q1) is used to provide variable average power levels to a load, as might be used for dimming an incandescent lamp. (Not shown are possible standard triac control circuit enhancements, including a gate driver circuit and a snubber circuit.) In parallel with the triac is a normally open relay switch contact 103 (SW1), with the relay coil 102 (L1) being used to activate the relay. (Similarly, not shown are typical relay implementation details such as a back biased diode in parallel with the coil, and a possible series resister and a control switching device such as a transistor or FET.)

When appropriate, as determined elsewhere, the relay switch is closed to provide a continuous power connection to the controlled appliance or load device. This will be done to control loads for which partial cycle switching mode is inappropriate, such as highly inductive loads and many electronic devices. Additionally, this will be done for high current loads such as hair dryers and space heaters, to prevent excessive thermal dissipation in the triac portion of the power control device.

For attempting to passively identify the nature of an attached load and determining its appropriate control approach, without fully turning on the load, the triac may be turned on briefly near the end of a half-wave power cycle, when the voltage is relatively low and the ‘on’ time duration until the end of the cycle will be short. During this time, the load current can be measured, along with its start-up phase delay characteristics, to determine the size of the load and whether it exhibits inductive characteristics.

This power control stage can also be used for transmitting data to cooperating appliances. For transmitting appliance control data, while in triac power control mode the turn-on time of triac relative to the zero crossing point can be shifted earlier or later by the controlling microcomputer to communicate a ‘0’ or ‘1’ bit state per half-cycle, or possibly a larger number of time offset positions could be used to communicate multiple bits worth of data per half cycle.

### FIG. 2: Current Sense and Appliance Data Receive Circuit

FIG. 2 shows one approach for implementing load current sensing and appliance receive data detection in the power control device. In this figure, the Power Control Circuit from FIG. 1 is connected to the Line Voltage source via a low-ohm current sense resistor 203 (R1). Note that the local circuitry is referenced to the Line Voltage side of the power feed rather than the Line Neutral side—while technically functional either way, implementing it in this fashion leaves the Line Neutral side connected to the Load at all times, while switching the Line Voltage side, while avoiding any need to provide high side control signal isolation.

The current sense non-inverting amplifier 204 (U1) and inverting amplifier 205 (U2) provide a full-wave rectified Current Sense signal to the microcontroller, and to the Appliance Receive Data detection circuitry. For Load current measurements alone, a half-cycle single current sense amplifier would probably suffice. By providing full-cycle current sense amplification, the Appliance Receive Data circuit can receive Appliance data sent during either half of the cycle, allowing the Appliance side circuitry to be implemented in a simpler manner than would otherwise be the case. Since some two-prong power plugs can be inserted in either orientation, the appliance itself does not necessarily know which half cycle is the positive or negative going interval.

Alternatively, the current sense circuitry in the Power Control Device can be implemented as a half-wave detection circuit by leaving out either amplifier 204 (U1) or 205 (U2). In this case, appliance side circuitry should be capable of sending data in either half cycle.

The detected current sense signal is connected to the comparator 206 (U3) via a high-pass capacitor configuration, with a small negative bias on the comparator inputs to ensure the output signal is held LOW when data is not present. To avoid accumulating an offset bias, the data can be sent in an encoded stream with a balanced number of ‘0’s and ‘1’s, as might be done by sending each bit followed by its complement. The comparator output is connected to an interrupt input on the Power Control Device microcontroller. The microcontroller receives a bit sequence, verifies it meets proper bit sequence expectations, and interprets the data and/or sends the data on to a system automation controller.

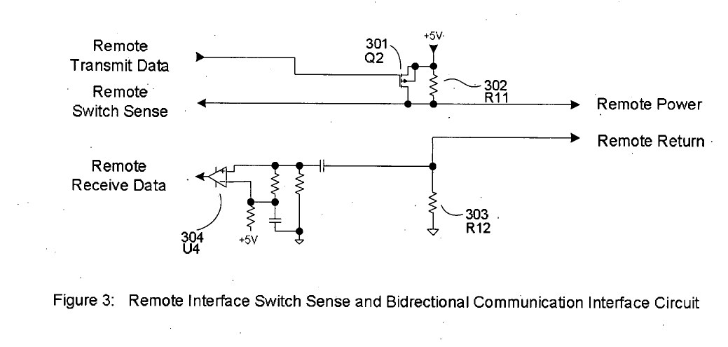

### FIG. 3: Remote Interface Switch Sense and Bidirectional Communication Interface Circuit

FIG. 3 shows an implementation for providing a flexible interface to remote (or local) user interface elements. A simple configuration example is a case where the Power Control Device is a dual receptacle unit, and there is a (possibly preexisting) two conductor wire running to a single traditional non-electronic wall switch. In this case, the circuit is operated with the FET 301 (Q2) in a non-conducting state, and the simple remote switch is connected to the relatively high resistance value 302 (R11) and the very low current sense resistance value 303 (R12). The Remote Switch Sense line can then be read to determine if the simple switch is in an open or closed state.

The remote interface circuit can also be used to provide more complex two-wire bidirectional communications with a remote user interface panel or other interface device. Additionally, the same two wires can provide power to the remote panel to operate electronic components and to provide power to user interface elements such as LEDs and LCD displays. In the implementation shown, data is received from the remote panel by detecting current mode modulation on the return line, with the sensed current level coupled to a comparator 304 (U4) through a high-pass capacitor configuration. This receive data circuit is similar to the one described for receiving appliance data.

In the more complex control panel case, the FET 301 (Q2) is normally in a fully conducting state, providing power as needed to the remote panel without incurring a significant drop across 302 (R11). To communicate from the Power Control Device to the remote panel, the FET 301 (Q2) is pulsed between ON and OFF states to send ‘0’ and ‘1’ data bits to the panel. As an example, a short OFF pulse could be used to send a ‘0’ bit and a longer OFF pulse could be used to send a ‘1’ bit to the remote panel.

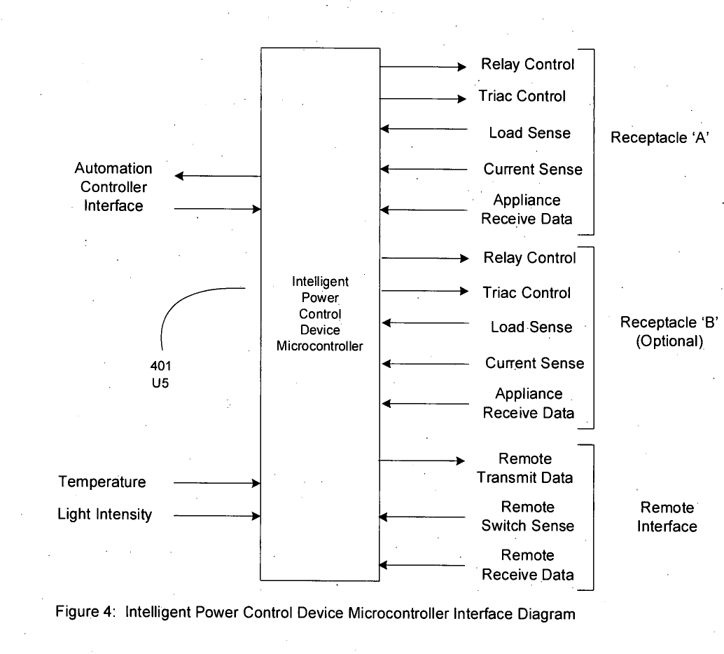

### FIG. 4: Intelligent Power Control Device Controller Interface Diagram

FIG. 4 shows possible signal connections to and from a Power Control Device microcontroller circuit. In this figure, standard microcontroller circuit implementation details such as clock, reset circuitry, zero crossing detector, and voltage reference are assumed and not shown. Also assumed is appropriate signal level interfacing between the indicated signal inputs and outputs and the associated circuitry shown in other figures.

The microcontroller 401 (U5) controls the power control triac(s) and relay(s) to one or more load devices or appliances, measures load currents and possibly communicates with the load appliances.

If remote I/O is connected, the microcontroller communicates with the remote location to sense inputs from the remote and/or send data to the remote. This data may be used by or originate directly from the Power Control Device, and/or exchanged with a system automation controller to assist in implementing centralized device configuration and/or control.

Any one or more of many communication methods can be used to communicate with an automation system controller, or peer-to-peer with other devices in cases where supported by the communications method. Such methods include hard-wired approaches such as RS-485 and FGI network technology, power line carrier methods such as X-10, CEBus, and UPB, and wireless methods such as Z-Wave and ZigBee. Interface circuitry to implement communications via these protocols is not shown, and can be implemented in the customary fashion for the chosen interface approach.

Additional sensors may be monitored by the Power Control Device, such as temperature and light intensity sensors. Sensor measurement data may be used directly by the Power Control Device to influence its control over the load, and/or sent to the system automation controller and/or sent to the remote user interface panel.

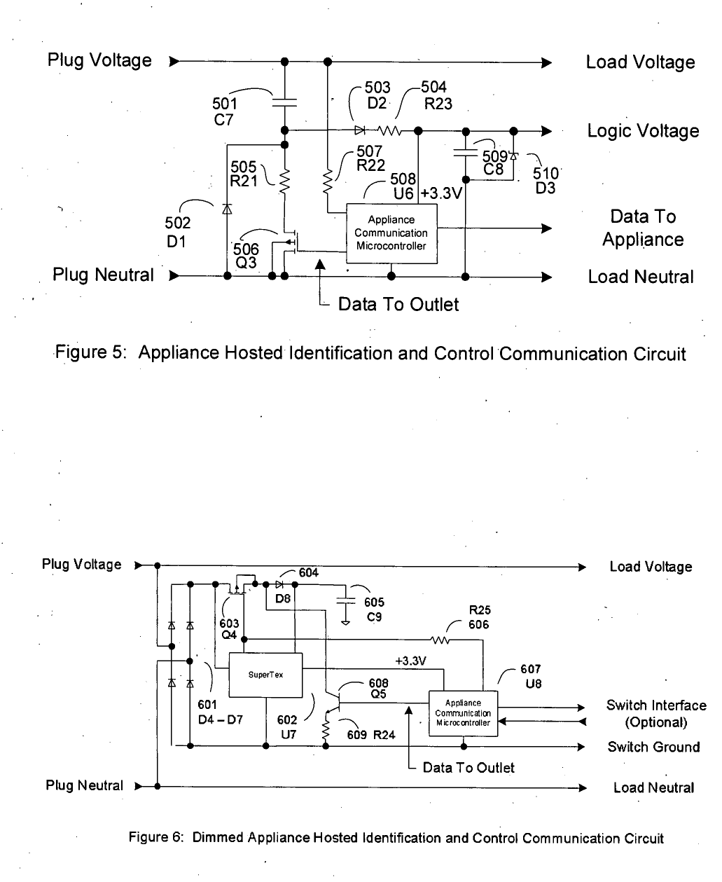

### FIG. 5: Appliance Hosted Identification and Control Communication Circuit

FIG. 5 shows an implementation of an Appliance communication circuit, as could be incorporated into an appliance or plug adapter to provide appliance identification information to the Power Control Device and/or automation system controller, and to exchange bidirectional status and control data with the Power Control Device and/or automation system controller.

The capacitor 501 (C7) provides DC isolation from the AC line voltage, while providing enough coupling to allow effective communication with the Power Control Device. During each negative going half cycle, the diode 502 (D1) prevents the lower end of capacitor 501 (C7) from going significantly negative, while recharging capacitor 501 (C7) as needed to compensate for drains during the previous cycle. On the positive half cycle, the diode 503 (D2) is forward biased, allowing the circuit's local power supply capacitor 509 (C8) to be charged. Zener diode 510 (D3) prevents the local supply from exceeding a comfortable voltage, and resistor 504 (R23) limits current flow through the charging circuit to a value close to that needed to meet the circuit's power needs.

The resistor 507 (R22) is used to provide a cycle polarity or zero crossing indication to the Appliance Communications Microcontroller, which is used to time its communications transmissions to the Power Control Device, and to receive data communications from the Power Control Device. When the resistor 507 (R22) input signal is HIGH, the circuit can transmit to the Power Control Device by switching FET 506 (Q3) ON and OFF, which causes a current to flow (or not) through resistor 505 (R21). This resistor is sized to conduct a significant enough amount of current to be detected by the Current Sense/Appliance Receive Data comparator circuit in the Power Control Device (FIG. 2). By keeping ON state pulses short, thermal dissipation by the FET 506 (Q2) and resistor 505 (R21) can be kept low, while improving the detectability of the signal by the high pass coupled data receive circuitry. Note that capacitor 501 (C7), diode 502 (D1), and FET 506 (Q3) must tolerate line voltage operation.

Assuming data is transmitted from the Power Control Device to the Appliance circuitry via modulating the triac turn-on position relative to the power source zero-crossing position, the data sent to the appliance can be decoded by monitoring the pulse width present on the microcontroller side of resistor 507 (R22). While no data is being transmitted, the pulse width will typically stay constant, with the width dependent on dimmer ON state duty cycle. While data is being transmitted, the duty cycle will vary with shorter and longer pulses indicating ‘0’ and ‘1’ data bits.

### FIG. 6: Dimmed Appliance Hosted Identification and Control Communication Circuit

FIG. 6 shows an implementation of a Dimmed Appliance communication circuit, as could be incorporated into an appliance or plug adapter to provide appliance identification information to the Power Control Device and/or automation system controller, and to exchange bidirectional status and control data with the Power Control Device and/or automation system controller.

This alternative implementation to that shown in FIG. 5 uses a current source configuration (transistor 608 (Q5) and resistor 609 (R24)) to replace the functionality of FET 506 (Q3) and resistor 505 (R21) in FIG. 5, allowing effective operation over a greater range of variations in the power-on duty cycle length if installed in a dimmer controlled device such as a lamp.

In FIG. 6, the SuperTex (brand name) power supply component 602 (U7) and surrounding diode bridge components 601 (D4-D7), FET 603 (Q4), and capacitor 605 (C9) provide a switched low voltage power supply implementation, as is commonly used with this commercially available power supply component. In this circuit, the FET gate control signal is connected via resistor 606 (R25) to the Appliance Communication Microcontroller 607 (U8) to indicate when the FET circuit is in a conductive state (which is during the low voltage portion of the beginning and end of each power line half wave cycle). During this time, the current source transistor 608 (Q5) can be modulated to communicate from the Appliance circuit to the Power Control Device circuit. The diode 604 (D8) has been added to the usual SuperTex circuit to prevent the current source modulation from drawing the current from capacitor 605 (C9) instead of from the intended Plug Voltage source.

Communication to the appliance is not shown in FIG. 6. A pulse position modulation receive data communication implementation similar to that shown in FIG. 5 can be added to FIG. 6 by connecting a resistor divider across the diode bridge, and connecting the center point of the divider to a receive data input pin on the Appliance Communication Microcontroller U8.

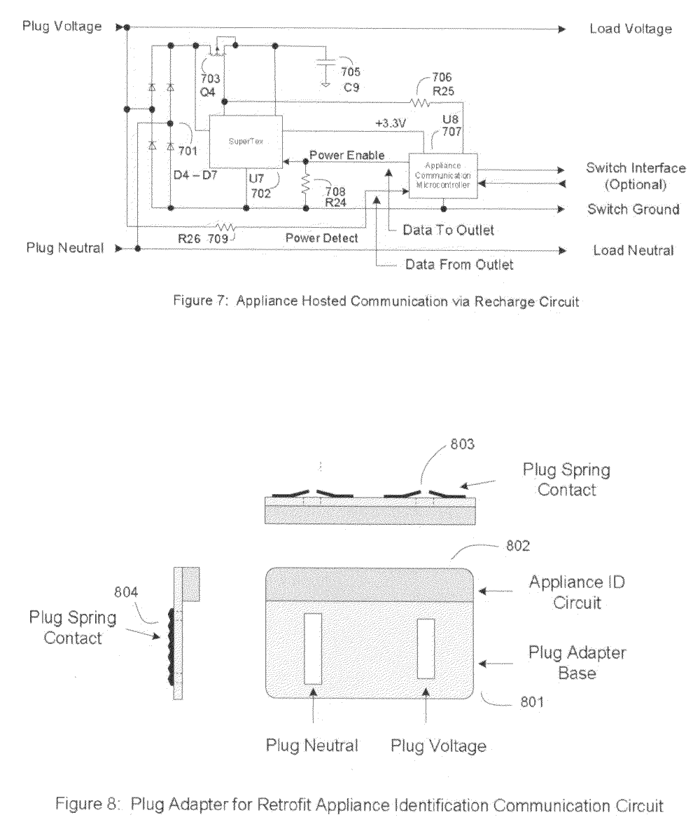

### FIG. 7: Appliance Hosted Communication via Recharge Circuit

FIG. 7 shows an implementation of an Appliance communication circuit, as could be incorporated into an appliance or plug adapter to provide appliance identification information to the Power Control Device and/or automation system controller, and to exchange bidirectional status and control data with the Power Control Device and/or automation system controller.

This alternative implementation to that shown in FIG. 6 controls the timing of the current surge produced by recharging the power supply capacitor 705 (C9) to replace the functionality of the current source implemented by transistor 608 (Q5) and resistor 609 (R24) in FIG. 6. This produces a large signal which is more easily detected by the current sense circuitry in the power outlet, and reduces the parts count used in the implementation. It also reduces the potential data rate of the appliance to outlet communication.

In FIG. 7, the SuperTex power supply component 702 (U7), diode bridge 701 (D4-D7), and surrounding components 703 (Q4) and 705 (C9) provide a switched low voltage power supply implementation, as is commonly used with this commercially available power supply component. In this circuit, the FET gate control signal is connected via 706 (R25) to the Appliance Communication Microcontroller 707 (U8) to indicate when the FET circuit is in a conductive state (which if enabled is during the low voltage portion of the beginning and end of each power line half wave cycle). When the FET 703 (Q4) turns on during the end of a power line half cycle, a current surge rushes in to recharge capacitor 705 (C9). The Power Enable line on the Supertex component 702 (U7) is controlled by the Appliance Communication Microcontroller 707 (U8) to send data to the Power Control Device encoded in the timing of the current surge. Resistor 708 (R24) holds the Power Enable line LOW when the Appliance Communication Microprocessor is in reset state, to ensure that sufficient voltage is provided to operate the Appliance Communication Microprocessor.

In this example, communication from the Power Control Device to the appliance is implemented using pulse position modulation, by controlling the turn-on time of the Triac supplying power to the appliance. A Power Detect signal is provided to the Appliance Communication Microcontroller 707 (U8) by connecting the Plug Voltage to a pin on the microcontroller through the resistor 709 (R26). This Power Detect signal is also used by the Appliance Communication Microcontroller as a timing reference for modulating the current surge timing to communicate from the appliance to the Power Control Device.

### FIG. 8: Plug Adapter for Retrofit Appliance Identification Communication Circuit

While the Appliance ID circuitry will ideally be built into the appliance or load device, in practice many appliances are in use that do not have such and ID circuit installed, and substantial penetration into new appliance designs is not assured. FIG. 8 shows a thin plug adapter design that can be attached to an appliance plug to retrofit the appliance with an appropriate device type ID and unique device ID code.

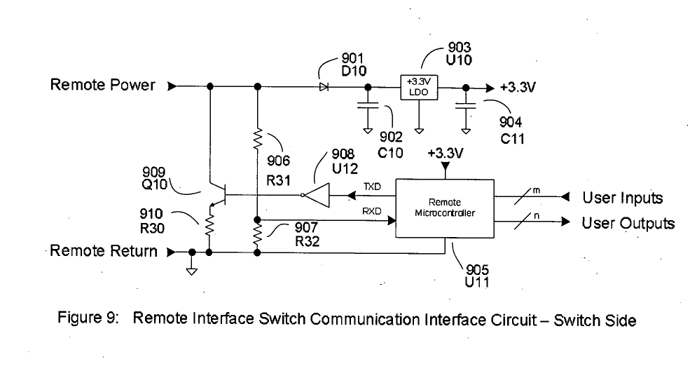

### FIG. 9: Remote Interface Switch Communication Interface Circuit—Switch Side

FIG. 9 shows a practical implementation of a circuit for the user interface side of communication with the Power Control Device via the Remote Interface Circuit shown in FIG. 3. In this circuit, power to the circuit and bidirectional communication with the Power Control Device is accomplished on the Remote Power/Remote Return two wire interface.

In this circuit, transmit data (TXD) communication to the Power Control Device is accomplished by modulating the current drawn by the remote interface circuitry, by switching the current source circuit implemented with transistor 909 (Q10) and resistor 910 (R30). Inverter 908 (U12) is used if needed to establish a default condition where the current source circuit is in the OFF state. Receive data (RXD) communication from the Power Control Device is accomplished by monitoring the Remote Power voltage level, here divided by resistors 906 (R31) and 907 (R32) to prevent the HIGH level from exceeding the power supply voltage on the Remote Microcontroller 905 (U11). Any serial protocol can be used, including standard UART protocols.

Diode 901 (D10) isolates the circuit's power supply (capacitor 902 (C10), linear voltage regulator 903 (U10), and capacitor 904 (C11)) from the communication signals on the Remote Power line.

Many user interface alternatives can be implemented as desired, limited mainly by available power. For example, a simple interface panel might have switches and/or rotary dimmer knob encoders for user input, possibly with LED status indicator light outputs. As another example, a panel with an LCD display and keypad or button input might be implemented, as might typically be used as a security system interface or a wall mounted thermostat (in the thermostat example, the panel might also incorporate a temperature sensor that also communicates via the Remote Interface). As another example, a graphics based color LCD touch screen console might be used for the user interface, with communications to the Power Control Device and/or an automation system controller via the Remote Interface.

### DETAILED DESCRIPTION OF INVENTION

The Intelligent Power Control Device is designed to efficiently and effectively meet many of the demands of automation and control systems ranging from Industrial to Home automation. Till now, too much time is spent adapting the user to the automation system instead of adapting the automation to the user. In home automation in particular, it is important for the automation system to be as transparent as possible and usable at a reasonable level of functionality by individuals having no knowledge of the system. The Power Control Device shifts the paradigm in favor of the user/homeowner. Dual-mode, current sense, and appliance communication are basic tools which allow for a nearly transparent, user friendly automation system. The goal is to be able to design and install a system without specific knowledge of the way the system will be used. If the user decides to utilize the automation in a different fashion than initially planned, there is no need to change out hardware and often no need to really alter software. One of the major obstacles has been lack of Dual-mode devices which can provide dimming capability and higher current switching capability which is seamless and automatic and incorporated into the same device. This allows devices such as a “universal outlet” receptacle which can handle sophisticated automation tasks as well as simply replace a common wall outlet. In the past you had to make the decision to install a dimmer module or a switching module according to what you planned to do with that particular outlet. With dual mode it doesn't matter, you have both functions available automatically. The Power Control Device can be incorporated into the outlet itself instead of just at switch locations as is usually done presently. You can control every outlet individually (each half of a duplex outlet) without “home run” AC lines or other special high voltage (AC) wiring. Combine Dual-mode with Appliance communication and current sense and you have an extremely high level of functionality that is not very sensitive to obsolescence (especially with hardwire backbone).

The Power Control Device consists of various combinations of components or modules appropriate to the application. Modules can be incorporated into a single Power Control Device or distributed.

Microprocessor and non-volatile memory module: This controls the functionality of the Power Control Device. Inputs and outputs are provided for all the modules as well as remote I/O (switches, sensor etc.). The non-volatile memory is used for imbedded programming and for recovery from power outage, controller failure, or other failsafe or default conditions. (Down load/up load)

Current varying module: Triac or similar dimmer function technology is used to provide dimmer function to appliances such as incandescent lamps or other devices tolerant of variable current. Some appliance communication methods utilize Triacs.

ON/OFF switch module: a Relay or similar higher current low resistance device which provides on/off functionality and allows for handling much higher loads than variable devices like Triacs usually do (primarily due to thermal or cost considerations). A Relay or similar device can also be used to select the power supply source: Two or more power feed circuits could be connected to the Power Control Device and the appropriate “feed” selected. This allows for the same Power Control Device to deliver power from different sources and/or with different characteristics (voltage, cycles). Load balance of circuits, emergency backup, or even multi voltage capabilities can be handled (industrial applications in particular).

Current sensing module: provides load data to the Power Control Device for its direct use or to be reported to controller or other device and can also be used to initiate switching between Triac operation and Relay operation. If Triac is rated to 300 watts and a higher current is sensed, the current sense can initiate extinguishing power, switchover to relay mode, or, alternately, can just reduce Triac output down to acceptable level (below 300 watts). What happens and when, can be programmed into the Power Control Device or controlled by external controller or both. There are endless uses for knowing the current draw of an appliance in automation systems from efficiency to fault detection/correction.

Temperature sense module: allows reporting of thermal load to Power Control Device which can be used to trigger switchover between Triac and Relay mode (to reduce or eliminate triac thermal load). Parameters can be programmed into the Power Control Device and/or external controller. Automation system can use temperature data in any way it sees fit (safety, efficiency etc.).

System Communication module: this can be any backbone system—be it hardwire, RF, IFR or other optical, carrier current, or whatever is available. There can be multiple Communication modules in the same Power Control Device. The Communication module is what ties the Power Control Device into an automation system, typically but not necessarily using an automation controller (Peer to Peer can be done as well). Some of the communication methods include X-10, LonWorks, CeBus, Z-wave, FGI, Bluetooth, UPB, ZigBee, RS-485 to name a few. Present or future methods can be implemented as needed/desired.

Appliance Communication Module: This is the module that “talks” to the appliance and while typically active, can be passive. Numerous methods can be deployed, ranging from Mechanical, Magnetic, Optical, Resistor-capacitor, Inductor-capacitor, to Power Modulation or RF etc. Multiple methods can be implemented in the same Power Control Device. This communication channel carries data to and from compatible or adapted (smart) appliances (from simple read “I.D” from appliance or it's tag to bi-directional duplex). Sneak a peek passive techniques can be used to analyze standard or “dumb” appliances. Simple implementation might be to just determine generic category of appliance (dimming allowed, dimming not allowed, for instance). Up from that would be more detailed ID such as class of appliance or specific serial number. From there, just about any data can be transferred back and forth. Outputs from the appliance might be switch states (on/off, dimmer setting, auxiliary switches) or maybe sensors (any kind) while typical inputs to appliance could be to display data, turn on indicators, initiate functions or download data etc. Terminal like functionality of an appliance is Dependent on the bandwidth of the method used to communicate and the performance needed/desired for the system. A home automation controller could download programming into electronic devices such as VCRs, televisions, alarm clocks, radios as well as collect data from them. A basic ID (serial number etc.) smart appliance could be as basic as a module attached to the AC power cord plug on the appliance. It can be imbedded in the plug or attached to it allowing very simple cheap adaptation of “dumb” appliances. ID only function does not require purpose built appliances or alteration to the appliance beyond the plug adaptation. This adaptation can be as simple as an adhesively attached tag or decal On upper end can be optical channel using fiber optical or light pipe conductor from appliance to plug where the outlet can communicate with it (optical transceiver I/O between blades of plug). Data can also be “passed through” outlet unaltered from backbone or auxiliary channel.

The Dual-Mode aspect is to allow extreme flexibility in dealing with both high current appliances and also lower current variable appliances such as incandescent lights with the same Power Control Device. A triac or similar technology is combined with a relay or other on/off high current switch device and a methodology for switching between them for current control. The Power Control Device selects the proper modality for the load size and type, be it Triac (or similar technology) for a light or other device desirable to vary current (dimmer), or Relay switched (or similar on/off device) for high current loads. If the Power Control Device were to be configured as an electrical outlet (receptacle), or a wall switch (on/off or “dimmer” type) connected to standard outlet, then you could plug in high current appliances such as a hair dryer (using relay mode) or plug in a lamp and control the intensity (Triac mode). No longer would any outlet need to be dedicated to one type of load or function. The Dual-Mode Power Control Device can be mounted anywhere in a circuit, from the before mentioned outlet to inline or at a switch location or breaker panel.

Determining which mode the Power Control Device operates in is determined by an array of methodologies. Simplest is preprogrammed or manual: outlet configured as (a) always on or always off, (b) on/off switching mode, or (c) dimmer mode. A second method is appliance sense through the Appliance communication module: once appliance is identified then preprogrammed options are available (dimmable, non dimmable, acceptable current ranges etc.) A third method is current sense: if a load is detected that exceeds the set limit for the triac, the mode would switch over to relay up to the limit set for that device. A fourth method is Temperature sense to trigger switchover of mode: if the triac or its environment reach a preset limit, then switchover to relay mode could be triggered (removing the heat generating triac from play). If desired, instead of switchover when a limit is exceeded, shutting down power to the appliance is another option. Operation of the Dual-Mode Power Control Device can be controlled by input from manual switches, sensors, automation controllers, other Power Control Devices and appliances through active or passive means.

The Power Control Device can be configured to make the determination itself or be controlled externally, usually by an automation controller. The Power Control Device does have the ability to function autonomously as well as be controlled by a larger architecture (automation system) giving it full flexibility. The Power Control Device is capable of reporting its status as well as the status of the appliance connected to it. Provision is made for active communication with cooperating appliances. Appliance identification (general as well as specific) can be sent to the Power Control Device and automation system controller. Data packets containing status information as well as instructions can be passed between the Power Control Device and appliance. Passive methods or “sneak a peek” are also available to evaluate appliance (resistive/non-resistive or other electrical properties).

Power Control Device communication with appliances can be accomplished by several methods: Magnetic, RF, optical (scan, bi-directional data link), color sensor, Mechanical Interface, Resistor-capacitor, inductor capacitor, current modulation, power switching position, pulse position modulation to name a few. These range from simple device type identification methods to complex bi-directional data communications. The appliance adaptation can be as simple as a decal attached to the plug up to a full function purpose built appliance.

Non-volatile memory enables multiple capabilities especially in cases of power outages or system failures. Defaults can be downloaded into the Power Control Device for dealing with various conditions and or failures. If there were to be a short outage, or glitch then having the Power Control Device come up in the same state as before outage might be desirable. If the outage were to be longer, it might be desirable for Power Control Device to come up in an “off” state. Response to controller or system failure might be to turn everything “on” (home outlets for example, where always on is a normal state). Whatever is desirable can be configured into the Power Control Device. Non-volatile memory also allows stand alone or autonomous operation.

### Some Basic Scenarios

### Home Automation:

Having control of, and communication with, some or all of the outlets, switches, sensors (temperature, humidity, illumination, current etc.), built in lighting circuits, installed and plugged in appliances, HVAC, hot water heater(s) and any other electrical or electrically controllable device would be extremely desirable for a full function home automation system. This can be done with Power Control Devices in conjunction with a controller and one of many communication strategies.

In a new construction house using a hardwire control link optically isolated from the high power components would be one method giving robustness and security. At time of construction adding the Bus wire is easy and cheap. Since many of the traditional high voltage switch wires can be omitted, wiring cost may be the same as traditional or even cheaper. One method is to place optical transceiver on the Power Control Device (configured as a wall outlet or wall switch) and the corresponding transceiver onto the in wall high power junction box with non-conducting plastic diode or light pipe intruding into the box which would provide optical isolation of control backbone (low voltage). Typically, wall switches would be connected directly to a node of the “hardwire” bus which is low voltage, although a Power Control Device can be used for switch inputs as well. The status of the switch can be determined (polled by the controller, actively transmitted-peer to peer etc.) by Power Control Device and/or by system. Lets assume a switch that can indicate variable values to control a dimmer function: The switch encodes a value to the controller via the low voltage bus and the controller sends a command to the Power Control Device associated with that switch over the hardwire bus which sets the level of the light connected/plugged into the Power Controller Device. The Power Controller device can sense the current being used by the lamp as well as the triac temperature and report this back to the controller. If for some reason the lamp exceeds safe or desirable capacity of the triac at the switch indicated level, several responses could be made. The Power Controller Device could (a) dim light to acceptable current draw, (b) switch over to relay function for full on, or (c) extinguish the light. Assumptions can be programmed into the controller so that depending on the appliance (lamp here) and the current draw, appropriate action can be taken. For example, if draw is over the 150 watt rating for this particular lamp but under 300 watts, the assumption could be made that too large a wattage bulb had been installed in the lamp and one solution would be to dim it down to 150 watts and the controller could set a flag for the condition so the homeowner would know to re-bulb the lamp. Over 300 watts could trigger extinguishing lamp suspecting a more catastrophic condition. Alternatively, if a large load is found, switchover to relay control might be desirable. The ability to know exactly what is connected, or in this case plugged into the Power Control Device would greatly improve the decision making process. If the appliance is “smart” meaning having a compatible communication capability, then the Power Control Device and by extension the controller would know what it was dealing with. In this case we will use a current modulation scheme for communication between “smart” appliances and the Power Control Device via the AC line (normal 2 prong plug on lamp with signal on top of AC). In the case of our lamp, we can tell the Power Control Device as detailed a description as desirable which is passed onto the controller also. In this case we will utilize a general category code (lamp, resistive, safe to vary or “dim”) as well as a unique identifier (serial number). Our controller knows from the ID or serial number exactly which lamp, its rated wattage, and any features it has. The category code allows for easier failsafe operation if controller fails since the Power Control Device can be programmed (via its non-volatile memory) to recognize and appropriately respond to these categories. (It can respond to specific serial ID's as well as long as non-volatile memory is appropriately sized.) Now that the system knows for sure what lamp is plugged in, it can deal intelligently with it and recognize out of specification performance. If it is a smart lamp, it does not need to mechanically open the power circuit internally, but instead communicates “requests” to the System via the Power Control Device which in turn controls the current into the lamp. In this mature system, we choose to send the request on to the controller and let the controller talk back to the Power Control Device for actuation. You could choose to have the interaction just between the lamp and the Power Control Device that it is plugged into (or just have it do that as a failsafe when the controller fails etc.). Since we have a “smart” lamp, it can have other devices or multiple switches incorporated into it and they can be polled and or controlled as well. Nearly limitless possibilities are available. We could choose to have turning on any lamp in a room to turn on all lamps in a room. A couple of extra controls on a lamp could allow local control of dimming of that lamp and/or any other lamps. Since you can read the status of the lamp and its buttons or controls, the controller can respond in anyway you wish to program the system, from the practical to the absurd. A smart appliance can have capabilities ranging from simple “one-way” or ID read function all the way to bi-directional terminal functions. We will now plug in a “smart” alarm clock, which is monitored and kept in proper time by the controller via the Power Control Device and current modulation communication link. The controller can set alarm settings, read inputs from controls on the clock and even let the clock display alternate data such as home burglar alarm status, temperature inside or out or in any zone, HVAC settings or just about any data the controller has access to and the clock display can handle. Since the clock is identified to the system, the Power Control Device and/or the controller knows not to vary the current supplied to it. (You can have a clock that varies its display intensity by direct control or better, through controller control—respond to time of day or room brightness etc.) If I set my alarm clock for 5:00 am and get up at 4:00 am and forget to disable the alarm (waking my spouse unnecessarily) I could have programmed the controller to detect my morning activity (switching on kitchen light, operating some morning activity specific appliance or even burglar alarm motion sensor downstairs) and automatically responding by canceling the 5:00 am alarm. If we unplug the clock and plug in a conventional (not smart) television to the just vacated receptacle, then the Power Control Device will be unable to actively communicate with the television and goes to the preprogrammed default which in this case is relay to “on” status. Even here, we can monitor and report load, Power Control Device temperature (and other inputs connected directly such as a light intensity sensor) and status to the controller (relay “on” in this case).

The controller can query and find every smart appliance that is connected within the entire system. We can authorize some appliances to operate only under certain conditions or in certain places (no band saw in the living room, no electric heater in bathroom, no TV after 10:00 pm in child's room or even password protect some appliances etc.). We can adjust the load on a circuit by looking at every appliance in use on that circuit and keep circuit from being overloaded and tripping a breaker by extinguishing or lowering low priority appliances.

This is really the tip of the iceberg, limited only by one's imagination. In this hardwire scenario, the hardwire bus connects all devices (Power Control Devices, switches, sensors, actuators, controller etc.) and provides its additional functionality. It lacks the vulnerability of a wireless system (no signals to intercept or spoof from outside) and has greater ruggedness and durability as well as economy. For existing homes, hybrids of wireless and hardwire look attractive.

### RF or Wireless Scenario:

Several technologies exist using RF and even IFR but for this example we will use Z-Wave 900 MHz RF system. Z-wave transceiver chips cannot only talk to each other they can “digipeat” or retransmit data. If a direct path is not possible between 2 Z-wave devices, they can leapfrog from device to device till it hits the intended device. With about a hundred foot range, you would need at least one device every hundred feet for system integrity (varies with material, obstructions etc.) Because we are focusing on maximum functionality this scenario utilizes a controller and for the most part all data is run through the controller with the controller evaluating the inputs and deciding and controlling the actuation of controlled devices. From the users point of view, the Z-wave equipped system operates mostly like the hardwire system. Each Power Control Device is Z-wave equipped and primarily talks to the controller over the Z-wave wireless “bus” or backbone. The one difference is that the Z-wave allows communication directly between devises without going through the controller. This can be used for failsafe modes or even as primary operating mode since the Power Control Device has non-volatile memory that can contain significant operating parameters and setups; but, as mentioned before, using the controller gives greater functionality.

A Z-wave equipped switch sends a request to the controller to locate all “smart” lamps and previously manually designated lamps in the living room and turn them on to a specific level (could be current level or even intensity if light sensors are employed). The controller finds and identifies the smart appliances (by pinging appliances through appliance interface current modulation in this model) as well as the specific receptacles that have been manually designated as having dumb lamps plugged in. The controller can now operate the lamps through their corresponding Power Control Devices and monitor the reports back from those Power Control Devices as well as information from the smart appliances themselves. The same array of communications options exist for communication between smart appliances and Power Control Devices in the RF backbone system as in the hardwire backbone system. The same abilities for Dual-Mode, current sense, temperature sense etc. exist here as in a hardwire platform. The advantage to RF is not having to run control lines or utilize any high voltage isolation techniques (no low voltage wires to protect). A wireless backbone or component allows for use of wireless portable remote control devices as well. Retrofitting with RF is attractive due to easier installation. Hybrid systems of hardwire where practical with RF to fill in the gaps provides a good compromise solution. Operation of multiple backbones in the same system is not a problem for Power Control Device systems and if done right retains or improves functionality.

### Assisted Living Facilities:

In assisted living situations, automation focus shifts from convenience to safety and empowerment of individuals. People can live on their own and more safely with automation assisting them. An automation system can be configured to look for certain conditions which may indicate a problem. If no appliances are operated or switches activated within a predetermined time then an alert can be sent to staff or family member to check on the individual. Appliances can be monitored for unsafe operation such as stove being left on too long. Sensors can be a valuable tool to determine health of premises and individuals living there. The ability to control where the appliance can be used can prevent injury. An electronic speech device can alert the inhabitants of unsafe or questionable situations (tied into an intercom would be desirable). If the premises are a part of a facility, then the management can keep track of faults or failures automatically. Management can override systems within a premise if required as well as track temperature, power usage, activities etc. In the case of a retirement home, retirement condos, or even detached houses, a system of hierarchical controllers could be implemented allowing for local control of most systems with supervisory access by management. All smart appliances could be equipped with a “panic” button (lamps etc.) to summon help. For pre-existing facilities hybrid hardwire and RF systems could be very effectively deployed. A hardwire bus could connect all apartments or houses and then a wireless bus could be utilize within the apartment without requiring the running of wires etc. Cordless RF remote controls as well as wireless call for help fobs could be easily used. In the case of RF systems like Z-wave, there are enough “house codes” to allow a very dense usage without fear of interference. The Power Control Devices would be placed in some or all existing outlet boxes and in place of existing manual dimmers. While the Power Control Device can accept a remote I/O such as a switch, it would probably be cheaper to just place a Z-wave node where wall switches are required. The Z-wave RF backbone connects all switches, outlets, and controller together for full function. A hardwire bus can also be connected to the controller if necessary to link to another system or in this example to the managements super controller. Ideally all appliances would be smart even if just ID smart, to allow for maximum ability to ensure safe operation. If the facility is new construction then hardwire could be the major backbone with some RF functionality to enable portable cordless devices such as remote controls etc. The Power Control Device easily handles these multi-backbone or even multi-protocol systems. This is important especially if some other automation equipment is already present. You could continue to use and support something like X-10 while at the same time going to higher functionality protocol backbone for newer or more sophisticated additions. At the power control and appliance communication level the Power Control Device is a complete solution for nearly any automation requirement.

### Business Automation:

### Office Building:

In an office setting you would have the same functionality as in home automation but probably different priorities. The ability to track all plugged in equipment and monitor it could be required. Using the simple ID modification to the power cord plugs on appliances would be sufficient to identify the appliance to the Power Control Device and through the backbone to the controller. By knowing what is plugged into or attached to a Power Control Device it is possible to know how to control the device and also to know when the device is operating out of specification (excessive current draw, or too little). Parameters can be set up allowing specific devices to only operate at certain times, locations or after password entry. Logs can be kept of what is being used where and when. With the addition of more sophisticated implementation such as modifying the appliance for bidirectional communication allows very sophisticated operation. Data can be retrieved from appliances as well as downloaded to them. A display plugged into a Power Control Device could receive data to display over the backbone and communicated to it through the appliance communication link. What you have is a communications network via the electrical connection to the appliance. For economy, full function Power Control Devices may not be required everywhere. The Triac or current varying module may be unnecessary. If only lighting is connected, perhaps Relay module would not be needed. Perhaps in some locations only current sense and communication to appliance is desired (no triac or relay) The do everything outlet is not as important as maybe it would be in a luxury home.

### Hotels

In a hotel environment, each room can not only have the convenience of automation for the guests, but also allow for much greater efficiency and ease of managing the facility. Unused rooms can be powered down or put to sleep. Other rooms can be “waked up” or readied for guests by turning on lights and bring room to proper temperature. You can monitor current use in a room by each appliance. You can sense disconnection of an appliance (TV, stereo, etc.) or where the appliances are connected. You can turn on or shut down appliances no mater where they are plugged in. You can use appliances optimized for handicapped people which greatly benefit from automation functionality. For deaf guests, alarms, doorbell, or even phone ringing could trigger the flashing of some or all room lights. If a fire alarm goes off, all lights in every room could be turned on or even cycled in order to not only notify guest to the situation but also provide illumination for ease of evacuation. Portable alarm devices such as bells or sirens could be plugged in anywhere and activated via the automation system and the Power Control Device. Portable sensors could likewise be deployed where needed and connected to the automation system by simply plugging them into any available outlet. The same with display panels, indicators or data input devices which only need to be plugged into an outlet to be connected to the automation system. Every Power Control Device is a portal into the automation system. You could monitor usage of items such as cleaning crew vacuum cleaners to determine which rooms have been vacuumed and by which vacuum cleaner. All clocks can be centrally regulated. Faults such as burned out light bulbs can be detected and system flagged for their replacement. Automated control of common areas as well as exterior lighting is simple and effective as well as much more efficient. Parameter such as environmental light intensity, time of day or even presence of people can contribute to efficiency improvements. Again, The Power Control Device allows control of current, measurement of current and other variables and a communications portal to any compatible appliance plugged into or attached to it. Data can go in and out of every Power Control Device which could be every electrical outlet in a structure.

### Schools

Efficiency and safety would be a large focus in automating schools. The ability to deny use of non authorized appliances could also be a factor. Theft control by detecting the unplugging of devices such as computers or TVs could be easily done. The ability to find a specific appliance anywhere in structure (provided it is plugged in) could be quite useful. Classrooms can be put to sleep or waked up according to use or schedule. Clocks can be regulated just by plugging them in. Depending on appliance and its communication abilities, many levels of faults can be detected. By measuring current draw, burned out lights can be automatically found and reported by automation system. Emergency lights in particular can be checked automatically for function. Maintenance is greatly enhanced by this ability to detect faults. Since schools rely on mostly built in lighting, probably most outlets would not need Dual-Mode but only Relay mode for current control. Hardwire backbone would be the most desirable but for ease of installation hybrids could be used.

### Hospitals and Clinics

Safety and efficiency can be increased here too. Some unique variations may exist due to regulations or codes governing such facilities. Even though electronic power control can be as robust and reliable as mechanical and often more so, in some situations it may be required to have a circuit or receptacle which has neither triac or relay function for fear of it being inadvertently switched off. Even in this situation, the ability to communicate with appliances and measure and report current draw could greatly improve reliability and safety. Being able to detect connection and disconnection of appliances is highly desirable (plug kicked from wall by accident would be detected) for safety as well as to track equipment. Purpose built equipment would be able to report internal faults or conditions as well as download/upload data or instructions. Hierarchal Controllers might be desirable to create subsystems for redundancy and to prevent overloading data channels (which depends on backbone and to some degree the appliance communication method used). Having switches and/or indicators (leds etc.) on the outlets themselves might be desired (to show status, confirm communication with appliance, initiate a modality, signal controller etc.). In a power outage or “brown out” situation where limited power is available, Power Control Devices allow the option of shutting down all non-essential appliances. Dual-mode functionality would be beneficial for waiting rooms, lobbies, or other areas where table and floor lamps are common. Using “Dual Feed” of power can be used for balancing loads or for emergency backup devices (generators, batteries).

### Industrial:

The ability to monitor and track equipment, control when and where each appliance can be used as well as upload/download data to appliances is of great benefit in industrial environments. Power Control Devices can be configured to control or communicate with existing protocols (Allen-Bradley etc.) Optional plugs, sockets, or wiring can be incorporated into the Power Control Device as needed. Data can be sent via backbone to Power Control Device where if necessary, the Power Control Device can properly format and translate the data (Power Control Device has non-volatile memory and microprocessor) into a form understood by the appliance. Using the backbone in this way can eliminate the “home run” control wiring usually needed to control smart industrial appliances.

### And More:

Other similar situations are Churches, Retail spaces, Restaurants, Child care centers, Jails and Prisons, Airport terminals, Bus Stations, just about anywhere can benefit from Power Control Device automation. In areas where there are small children it allows all outlet to be turned off except when an approved appliance is plugged in to greatly lessen chance of electrocution. Power Control Devices can be used with or incorporated into stage lighting appliances where the dual mode allows for relay mode for full on (less heat) and the current sense can allow for detection of present or imminent failure of bulbs. Also are the obvious advantages of finding and addressing lights and communicating with them (multifunction lights such as Showcos that can articulate, change light color etc.) The scenarios are endless. The question is not why automation but rather why not? In the past the why not has been the unavailability of the Power Control Device and its functionalities.

The Power Control Device is designed to overcome the major obstacles limiting progress in automation systems. The need for Dual-Mode device is obvious for seamless and easy utilization of automation. Dedicated purpose outlets are an unnecessary limitation on an automation system that seeks to offer flexibility and ease of use. The present configurations on the market offer separate devices for dimmer function and for on/off switch function. If an outlet is equipped with only a triac, then no high power devices can be connected. Dual Mode means every outlet in a building can serve any purpose. The communication link to the appliance provides immense functionality and potential limited only by imagination. The Power Control Device is an effective and elegant solution for automated power control and communication. The market will find unique and clever uses not presently envisioned because we have built in such an extraordinary level of functionality. The failsafe and default capabilities due to downloadable non-volatile memory provide confidence and safety when problems do happen. The non-volatile memory also provides the ability for autonomous or stand alone applications. The Power Control Device can add new protocols and communication standards as they are developed and become available. While the functionality will increase with availability of smart appliances designed for use with the Power Control Device, presently available or existing appliances can offer extremely high functionality to a Power Control Device automation system. With cheap and simple modification (decal stuck to appliance plug) of appliances, functionality not now available can be offered. Once the Power Control Device is considered with its capabilities, it is hard to imagine accepting the lower functionality of currently existing systems and the direction they are going. The Power Control Device concept for automation is a significant departure from existing concepts of automation. Our concept is universal, not dedicated and eliminates piecemeal approach to automation. While existing systems have addressed the built in appliance applications such as imbedded lighting (ceiling lights, exterior lights) or HVAC, they have mostly ignored the portable/movable appliance. The closest they come is offering a device that can be plugged into an ordinary outlet and then you plug an appliance into it. They are used to operate lamps or even a coffee maker. They are usually RF or power line modulation enabled for their command communication (backbone). X-10 dimmers or switches have been available for years but are not typically built into an outlet but are more an attachment for an appliance. They use triacs or relays but not both in same device and certainly not with current or temperature sense or communication with connected appliance. There are appliances such as X-10, which require only connection to an outlet to function and communicate. The weaknesses to X-10 are well known (range, noise, unintentional or malicious interference etc.). Other appliances are RF or hardwire and usually proprietary. The Power Control Device can adapt to these protocols although some are not attractive (X-10 etc.) due to unreliability and security issues. Even so, provision is made due to the large installed base of such systems. Again, existing concepts and systems are piecemeal approaches that pick and chooses what to control. The Power Control Device is designed to bring everything under control either by itself or by filling in the large gaps left by other systems and equipment.

Being able to install an automation system into a house, or even a business without having to give any thought as to how it will be used is now possible with the use of Power Control Devices. Even if you know exactly how it is to be used at present, what if it changes? With Power Control Devices most changes require little or no reconfiguring of the system and almost never require change out of automation devices. Reconfiguring the automation controller would be the extent of adapting to major change in system use or environment. Even here, menu driven intuitive point and click can do the job. Not being perpetually dependent on an automation specialist is now feasible even in a mature high function automation system. The Power Control Device configured as a wall receptacle could within a short time be the universal replacement for the standard wall receptacle. This is an extremely attractive application. While we have focused somewhat on the receptacle implementation, it is but one of many implementations practical for the Power Control Device. It can be incorporated into appliances, built in lighting, installed inside power distribution panels, replace switches and indicators, monitor and control circuits, support multi-protocol simultaneously, and provide data portals.

1) A Power Control Device having a relay with contacts in parallel with a triac, where the triac provides variable control over the average power level to a load, and the relay provides full power to the load.

2) A device as in claim 1, that automatically switches between triac power control and relay power control based on load current.

3) A device as in claim 1, that automatically switches between triac power control and relay power control based on load current phase relative to load voltage.

4) A device as in claim 1, that automatically switches between triac power control and relay power control based on temperature.

5) A device as in claim 1, that automatically switches between triac power control and relay power control based on duty factor.

6) A device as in claim 1, that automatically switches between triac power control and relay power control based on load type identification information.

7) A device as in claim 1, that automatically switches between triac power control and relay power control based on load type identification information read from the connected load.

8) A Power Control Device having a relay with contacts in parallel with a triac, where the triac provides variable control over the average power level to a load, and the relay provides full power to the load, controllable via an automation communications interface, that sends status information to the controlling source, where the status information includes the power control mode status, load status information, or both.

9) A device as in claim 8, where the automation communication is via a radio frequency data link.

10) A device as in claim 8, where the automation communication is via a modulated power line carrier data link.

11) A device as in claim 8, where the automation communication is via an optical data link.

12) A device as in claim 8, where the automation communication is via a low voltage signal wired data link.

13) A Power Control Device that transmits data to a connected load by modulating the load voltage turn on time relative to the line voltage zero crossing time.

14) A device as in claim 13, where the Power Control Device has a power control relay in parallel with a triac power control device.

15) A device as in claim 13, also having an automation communications interface, where data received via the automation communications interface is sent to a connected load.

16) A Power Control Device that receives data from a connected load via load current modulation, where the data includes load identification information, status information, or both.

17) A device as in claim 16, where the Power Control Device has a power control relay in parallel with a triac power control device.

18) A device as in claim 16, also having an automation communications interface, where data received from a connected load is sent to a controller or other device via the automation communications interface.

19) An Appliance or Electrical Load Device that sends data to a Power Control Device by modulating the power line load current, where the data includes load identification information, status information, or both.

20) An Appliance or Electrical Load Device as in claim 19, that sends data to a Power Control Device by controlling when its power supply draws current from the power line, where the data includes load identification information, status information, or both.

21) An Appliance or Electrical Load Device that receives data from a Power Control Device by decoding modulation of the load voltage turn on time relative to the line voltage zero crossing time.

22) A Power Control Device that communicates with a remotely located user interface device via modulation on a low voltage two wire interface, where the interface wiring is not isolated from the electrical power line voltages.

23) A device as in claim 22, where the communication data is sent to the remotely located interface by modulating a voltage on the two wire interface.

24) A device as in claim 22, where the communication data is received from the remotely located interface by decoding modulation of the current drawn by the remote interface.

25) A device as in claim 22, also having an automation communications interface, where communication data received from the remotely located interface device is sent to a controller or other device via the automation communications interface.

26) A device as in claim 22, also having an automation communications interface, where communication data received via the automation communications interface is sent to the remotely located interface device.

27) A device as in claim 22, where upon user interaction with a remote switch, the power control device sends the switch status via an automation interface, and the power control device does not change its power control state except possibly in response to an external controller or device
a) failing to acknowledge the switch status message,
b) failing to respond to a query, or
c) failing to send a communication within an amount of time.

28) A Remote Interface device that communicates with a Power Control Device via modulation on a low voltage two wire interface, where the interface wiring is not isolated from the electrical power line voltages.

29) A device as in claim 28, where the communication data is received by the Remote Interface Device by decoding a voltage modulation on the two wire interface.

30) A device as in claim 28, where the communication data is sent from the Remote Interface Device by modulating the current drawn by the Remote Interface Device.

31) A power control device, which has a set of operational characteristics when the presence of an automation controller is detected, and a different set of operational characteristics when the presence of an automation controller is not detected.

32) A power control device as in claim 31, with a local manual switch control, where upon user interaction with the switch, the power control device sends the switch status via an automation interface, and the power control device does not change its power control state except possibly in response to an external controller or device
a) failing to acknowledge the switch status message,
b) failing to respond to a query, or
c) failing to send a communication within an amount of time.

33) A Power Control Device that receives data from a connected load, where upon receiving data from the connected load, the power control device sends status information via an automation interface, and the power control device does not change its power control state except possibly in response to an external controller or device
a) failing to acknowledge the status message,
b) failing to respond to a query, or
c) failing to send a communication within an amount of time.

34) A Power Control Device that detects the presence or absence of a connected load, where upon detecting a change in the connected load status, the power control device sends status information via an automation interface, and the power control device does not change its power control state except possibly in response to an external controller or device
a) failing to acknowledge the status message,
b) failing to respond to a query, or
c) failing to send a communication within an amount of time.

35) A power control device with a local manual switch control, where upon user interaction with the switch, the power control device sends the switch status via an RF transmission, and the power control device does not change its power control state except possibly in response to an external controller or device
a) failing to acknowledge the switch status message,
b) failing to respond to a query, or
c) failing to send a communication within an amount of time.

36) A system having a power control device that reads an identification code from a connected load, or a device attached to the load, and uses that identification code to charge an account for using electricity from the power control device.

37) A system having a power control device that reads an identification code, priority code, and/or electrical demand requirements from a connected load, or a device attached to the load, and uses that identification or priority code or demand requirement to allocate electricity from the power source or control the generation output of the power source.

38) A system having a power control device that reads control or status data from a connected load, or a device attached to the load, and uses that data to control the operation of the power control device or another device associated with the connected load.

39) A power control device that can use an identification code read from an attached load as a control address, either to control the power delivered to a connected load or to route data to a connected load or device associated with the connected load, such that a system controller can control a connected load by addressing the load rather than the power control device.

40) A controller that controls load communication enabled power control devices, where the system controller selects a power control device to control based on an identification code read from a load connected to the power control device.

41) A controller that controls operation of a system, power control devices, or connected load appliances or devices, based on status or control data sent from a load that is delivered to the controller via a load communication enabled power control device.

42) A system that allows or prevents delivery of power to a load based on an authorization status associated with an identification code read from the connected load or device attached to the connected load.

43) A system that uses a load identification code read from a connected device or appliance by a load communications enabled power control device to determine the presence or absence of a device or appliance or location of connected devices or appliances.

44) A power control device that uses settings provided by a controller or connected load device or appliance to determine the power control devices default behavior in absence of communication from a controller or after power has been restored after a power outage.

45) A load device or appliance that uses device or appliance type default settings or settings provided by a controller to determine the load device or appliance behavior after a loss of communication or after power has been restored after a power outage, or to provide a power control devices to which it is connected with default settings to use in the absence of communication from a controller or after power has been restored after a power outage.
